(19) United States
(12) Patent Application Publication
(10) Pub. No.: US 2008/0104275 A1
(43) Pub. Date: May 1, 2008

(54) VISUAL GUIDANCE AND VERIFICATION FOR INTERCONNECTING NODES

(76) Inventors: Jason Robert Almeida, Raleigh, NC (US); Willliam Bradley Schwartz, Apex, NC (US); Edward Victor Zorek, Cary, NC (US)

Correspondence Address: IBM CORPORATION (SS/NC);c/o STREETS & STEELE, 13831 NORTHWEST FREEWAY, SUITE 355, HOUSTON, TX, 77040, US

(21) Appl. No.: 11/555,022

(22) Filed: Oct. 31, 2006

(51) Int. Cl. G06F 15/173

(52) U.S. Cl. 709/243

(57) ABSTRACT

Systems, methods, and software for guiding electronic connections between nodes of a computer system are disclosed. A system includes a plurality of servers, each having a plurality of connection ports and a service processor in electronic communication with the connection ports. A plurality of selectively-operable visual indicators are included, each associated with one of the connection ports. One of the service processors controls operation of the visual indicators according to a sequence of electronic connections to be made between the connection ports. Computer usable program code accessible by one of the service processors may be included for selectively operating visual indicators associated with the connection ports according to the sequence of connections to be made between the servers.

### BACKGROUND OF THE INVENTION

1. Field of the Invention

The present invention relates to connections to be made between nodes of a computer system.

2. Description of the Related Art

Networked computer systems typically include a plurality of interconnected nodes. In the context of networked computer devices, a node is a processing location having a unique network address. Thus, a node can be a computer or some other electronic device, such as a printer. For example, a computer system may include a plurality of servers, each being an individual node. Each server generally includes a plurality of connection ports for interconnecting the servers in particular configurations. These interconnections are commonly employed to achieve scalability.

Interconnecting servers often requires making connections between servers in a specific sequence. Configuring computer systems can, therefore, be challenging, particularly with more complex computer systems, such as those incorporating many servers. For example, interconnecting together an eight-chassis “x460” system with cables can be relatively complex and time consuming. Conventionally, the user must make the connections with the aid of a diagram in a user manual. Although diagrams are useful tools for guiding the connections to be made, particularly in the hands of trained personnel, the process of connecting the servers can still be complex and time consuming. Trained computer administrators may, for example, have the expertise to follow such diagrams, while less trained computer operators may lack the knowledge to make such connections, or to restore disconnected cabling connections when trained personnel are not available. Furthermore, even when a manual is properly followed, there is no guarantee that all cable connections in a complex partition have been properly performed. The steps involved in connecting servers represent a significant factor in the overall time, cost, and complexity of server installation and maintenance.

Therefore, there is a continuing need for improved ways to facilitate proper connections between nodes in networked computer systems. It would be desirable to have a method of interconnecting nodes that was simpler to follow, more reliably successful, required less time to implement, and did not depend on specialized training or experience.

### SUMMARY OF THE INVENTION

The present invention provides a computer program product comprising a computer usable medium containing computer usable program code for guiding electronic connections between nodes of a computer system. The computer program product includes program code usable by a service processor included with one or more of the nodes, for selectively operating visual indicators associated with connection ports included with the nodes according to a sequence of connections to be made between the nodes.

The present invention also provides a system comprising a plurality of nodes, each node including one or more connection ports and a service processor in electronic communication with the one or more connection ports, and a plurality of selectively-operable visual indicators, each associated with one of the connection ports, wherein a selected one of the service processors controls operation of the visual indicators according to a sequence of electronic connections to be made between the connection ports. Preferred visual indicators are selectively changeable between an illuminated condition and a substantially non-illuminated condition. These visual indicators may include, without limitation, LEDs, lamps, LCDs, and combinations thereof.

### BRIEF DESCRIPTION OF THE DRAWINGS

FIG. 1 is a schematic diagram of a computer system 10 having four servers 12-15 interconnected in a particular pattern.

FIG. 2 is a schematic diagram of the multiple servers in communication on the back channel, including an Advanced Programmable Interrupt Controller (APIC) bus.

FIG. 3 is a schematic diagram of an exemplary server having a plurality of connection ports and associated visual indicators for guided connection to a networked computer system.

FIG. 3A shows an example of a flexible, high-speed data cable that may be used to connect between two connection ports to provide electronic communication therebetween.

FIG. 4 is a schematic diagram showing a group of servers connected on a back channel for guided connection according to the invention.

FIG. 5 is a schematic diagram of the servers of FIG. 4, wherein one end of a cable has been connected to a connection port on one of the servers in response to illumination of a visual indicator.

FIG. 6 is a schematic diagram of the servers of FIG. 5, wherein another end of the cable has been connected to another connection port in response to illumination of another visual indicator.

FIG. 7 is a schematic diagram of the servers of FIG. 6, wherein one end of another cable has been connected to another connection port in response to illumination of another visual indicator.

FIG. 8 is a flowchart describing a method for guiding electronic connections between nodes of a computer system.

### DETAILED DESCRIPTION

The present invention includes systems and software for guiding the connection of nodes in computer systems. In particular, the invention may be used to guide a user in connecting servers according to a particular wiring or “cabling” configuration and/or wiring or “cabling” sequence. For example, a computer system according to the invention may guide the user through a complex cabling sequence using illuminating visual indicators disposed on or near electronic connectors and/or on cables. Visual cues provided by the visual indicators guide the user in sequentially connecting the servers or other devices according to the cabling configuration and sequence.

In one embodiment, a computer system includes multiple servers, each server having multiple connection ports, one or more computing processors, and a service processor. The servers may be connected using the multiple connection ports according to a particular cabling configuration, such as to combine the computing power of the servers. The cabling configuration typically requires connections to be made between the servers in a particular sequence. A plurality of selectively operable visual indicators is included with each server to help guide the connections. Each visual indicator is associated with a particular connection port. The visual indicators may include, for example, lamps, LEDs, or other illuminable or displayable device in proximity to the associated connection ports. Visual indicators may also be disposed on cables used to connect to the various connection ports, such as to indicate a successful cable connection.

The servers may initially be placed in electronic communication on a “back channel” using conventional cables, such as Ethernet cables. The order of connecting the cables on the back channel is generally not important, and a user may easily perform these connections with little or no guidance. The service processor on one of the servers is designated as the primary service processor, and is primarily responsible for controlling data communication between the servers on the back channel. The primary service processor accesses instructions, such as may be embodied in software, and which may be stored on the primary service processor or elsewhere in the computer system. The instructions may designate the ports to be connected and the sequence in which to connect them. The primary service processor, according to these instructions, selectively operates the visual indicators on the servers corresponding to the connection ports to be connected, to guide a user in connecting the servers. For example, the primary service processor may cause the visual indicators to sequentially illuminate according to the desired cabling configuration and sequence.

The cabling sequence may specify a sequence for individually connecting connection ports. Accordingly, the visual indicators may be individually operated in sequence. For example, a specific visual indicator may illuminate blue to designate a connection port to be connected. Once a connection is made to that connection port, the visual indicator associated with the next connection port in the sequence may be illuminated. Alternatively, the cabling sequence may specify a sequence of pairs of connection ports (“connector pairs”) to be connected, wherein each connector pair includes one connection port on one server and another connection port on another server. Accordingly, the visual indicators associated with both connection ports in the connector pair may be simultaneously operated. For example, both connection ports in the connector pair may be simultaneously illuminated blue. Once the connector pair is successfully connected, the visual indicators associated with the next connector pair in sequence may be operated.

Visual indicators may also visual confirm successful connections. For example, when a cable connector is successfully connected to a designated connection port, the visual indicator may change from blue to green, to confirm the successful connection. Separately or in combination with visual indicators on the server, a visual indicator on the cable itself may also illuminate to confirm a successful connection. Another visual confirmation may be provided when two connection ports are successfully connected. For example, when a connector pair is successfully connected with a cable (establishing a communication pathway between two servers), visual indicators associated with the connector pair may visually confirm that connection.

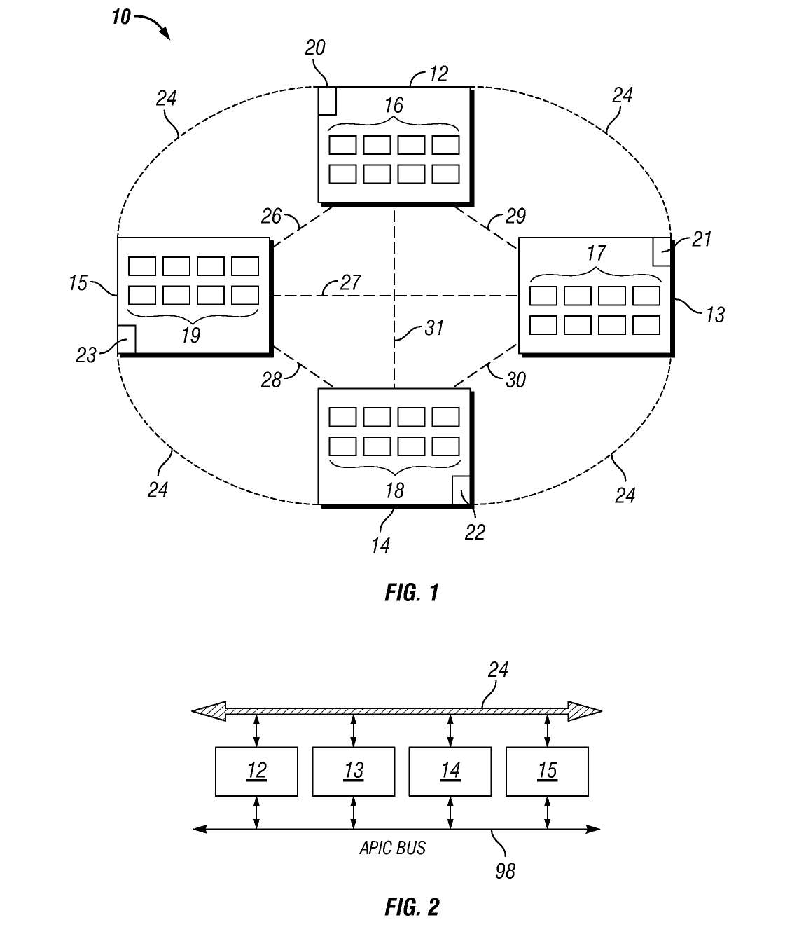

FIG. 1 is a schematic diagram of a computer system 10 having four servers 12-15 interconnected in a particular pattern. Details regarding connection ports and visual indicators are omitted in this figure. Each server 12-15 is a node in the computer system 10. Each of the servers 12-15 include, respectively, a set of eight processors 16-19 and a service processor 20-23. Other embodiments may have a different number of servers, or may include other devices configured with the servers. The service processors 20-23 are in communication on a back channel 24 using Ethernet cables or other conventional cables. The back channel 24 provides at least limited data communication between the servers 20-23 prior to other connections being made. Conveniently, the back channel 24 also optionally provides communication without the use of an operating system. One of the service processors, such as the service processor 20, is designated as the primary service processor, and the remaining service processors 21-23 may be subordinate to and receive instructions from the primary service processor 20. Likewise, the server 12, on which the primary service processor 20 resides, may be referred to as the primary node in the computer system 10. The primary service processor 20 at least partially controls or instructs the subordinate service processors, such as by electronically communicating information to the other servers 13-15 via the subordinate service processors 21-23.

Dashed lines represent connection pathways 26-31 between the servers 12-15. The connection pathways may be formed by connecting connection ports of one server with connection ports of another server with scalability cables. For example, the eight-processor servers 12-15 may be interconnected to effectively create a 32-processor computer system. Each connection pathway 26-31 may represent one or more connections made with one or more cables. For example, connection pathway 26 indicates one or more connections between the servers 12 and 15. Likewise, connection pathway 27 indicates one or more connections between the servers 13 and 15, and connection pathway 31 indicates one or more connections between the servers 12 and 14. The cables routed along the connection pathways 26-31 are typically very high-speed interconnect cables, such as proprietary IBM Modular Scalability Cables. However, other high-speed cables known in the art may alternatively be used. Optionally, three to four high-speed cables may be used along each of the connection pathways 26-31, for increased bandwidth. The high speed of data communication between the servers 12-15 may influence the optimal sequence of connections.

In the exemplary cabling configuration of FIG. 1, the desired cabling sequence may include sequential connections along connection pathways 26-28, followed by sequential connections along connection pathways 29 and 30, and finally, sequential connections along connection pathway 31. The selected cabling configuration and sequence may vary according to the application, and will also generally vary between computer systems. While the cabling configuration and sequence described with respect to FIG. 1 is relatively simple, the cabling configuration and sequence in other computer systems may be significantly more complicated, particularly in computer systems having a greater number of servers. In an actual computer system, the servers are rarely spatially arranged in the convenient pattern shown in the schematic diagram of FIG. 1. Furthermore, the cabling configuration and sequence in more complicated computer systems is generally not obvious or apparent on the basis of mere inspection, and may even be challenging with the aid of a conventional cabling diagram. Embodiments of the invention are therefore provided for facilitating the interconnection of nodes in a computer system.

FIG. 2 is a schematic diagram of how the multiple servers 12, 13, 14, 15 may be connected on the back channel 24. The service processors 20-23 may be designated by an Advanced Programmable Interrupt Controller (APIC) number known in the art, with the primary service processor 20 having the lowest APIC number. The lower APIC number is typically connected first within the computer system 10. An APIC bus 98 allows communication between processors and other devices in a manner that is not controlled by the operating system. This feature is advantageous for allowing servers to communicate on the back channel prior to configuring the computer system.

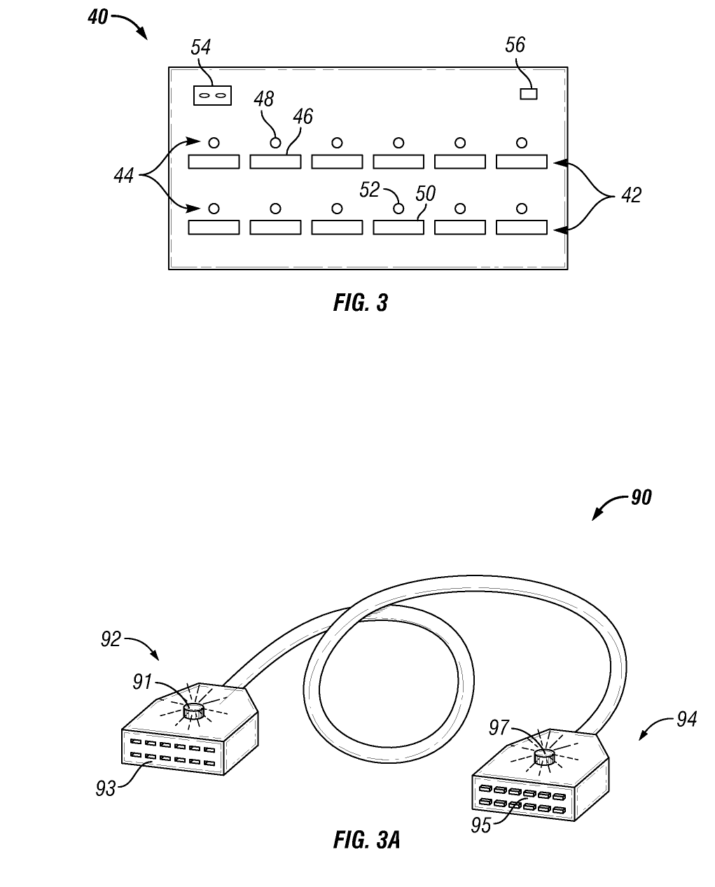

FIG. 3 is a schematic diagram of an exemplary server 40 having a plurality of connection ports 42 and associated visual indicators 44 for guided connection within a networked computer system according to the invention. The visual indicators may be LEDs, lamps, or other illuminable or displayable components. Each connection port 42 is an interface on the server 40 that may be electronically connected to a connection port on another server. Each connection port 42 may be in the form of an electronic connector (“connector”) disposed on the server. A connector generally includes one or more electrically conducting terminals for contacting one or more electrically conducting terminals on a mating connector (such as a cable connector), to provide electronic communication (such as signal or power transfer) between electronic devices. Most connectors also include a mechanical connection, such as a retention clip between a male connector and a mating female connector, which secures the mating connectors in a manner to maintain contact between the contacting terminals. Other features of the server 40 include a power port 54 and Ethernet ports 56. The power port 54 provides power input to the server 40, and the Ethernet ports 56 may provide for connection to a network and/or communication with another server on a back channel.

Each of the visual indicators 44 is associated with a particular one of the connection ports 40. For example, the visual indicator 48 is uniquely associated with the connection port 46, and the visual indicator 52 is uniquely associated with the connection port 50. The association between each connection port 42 and visual indicator 44 may be apparent to a user in a number of ways. In the embodiment shown, it is apparent from the layout of the server 40 that, for example, the visual indicator 48 is associated with the connection port 46 by virtue of the proximity therebetween. This association is further apparent by the optionally ordered arrangement of the connection ports 42 and visual indicators 44. Thus, it is reasonably apparent that the visual indicator 48 is associated with connection port 46, which is closest to and aligned with the visual indicator 48, rather than the connection port 50, which is more distant from and not aligned with the visual indicator 48. In other embodiments, a visual indicator may comprise an illuminable collar or other feature surrounding or directly disposed on a connection port, whereby the association between the visual indicator and the connection port would also be apparent. These are merely examples of illuminable visual indicators, and other types and configurations of visual indicators according to the invention will be appreciated by one skilled in the art having the benefit of this disclosure.

Disposing a visual indicator and its associated connection port in close proximity is not mandatory, however. Rather, it is possible to construct an embodiment according to the invention wherein selectively illuminable visual indicators are positioned remotely or structurally separated from their associated connection ports. For example, a panel of visual indicators structurally separate from a panel of connection ports may be associated by numbering or lettering adjacent the connection ports and visual indicators. The visual indicators may be visually linked with their associated connection ports. For example, a visual indicator may be labeled with a marking, such as a number or a letter of the alphabet. Its associated connection port may be labeled with the same number or letter, to indicate the association between the connection port and visual indicator.

Flexible high-speed data cables are typically used to connect between two connection ports to provide electronic communication therebetween. FIG. 3A shows an example of such a data cable 90. The data cable 90 typically include a connector 92, 94 on each end. One connector 92 is configured for mating with a connector on a first server or device, and the other connector 94 is configured for mating with a connector on a second server or device, to provide electronic communication along the data cable 90 between the connector ports on the devices. The connector 92 includes a plurality of pins 93 for mating with recesses in the connector on the first server or device. The connector 94 includes a plurality of recesses for mating with pins on the connector on the connector on the second server or device. The connectors 92, 94 each include an optional visual indicator 91, 97, such as an LED or lamp. The visual indicators 91, 97 are selectively operable to help guide a user in making connections between servers. For example, the visual indicator 91 may selectively illuminate in response to connecting with the first server or device, and the visual indicator 97 may selectively illuminate in response to connecting with the second server or device.

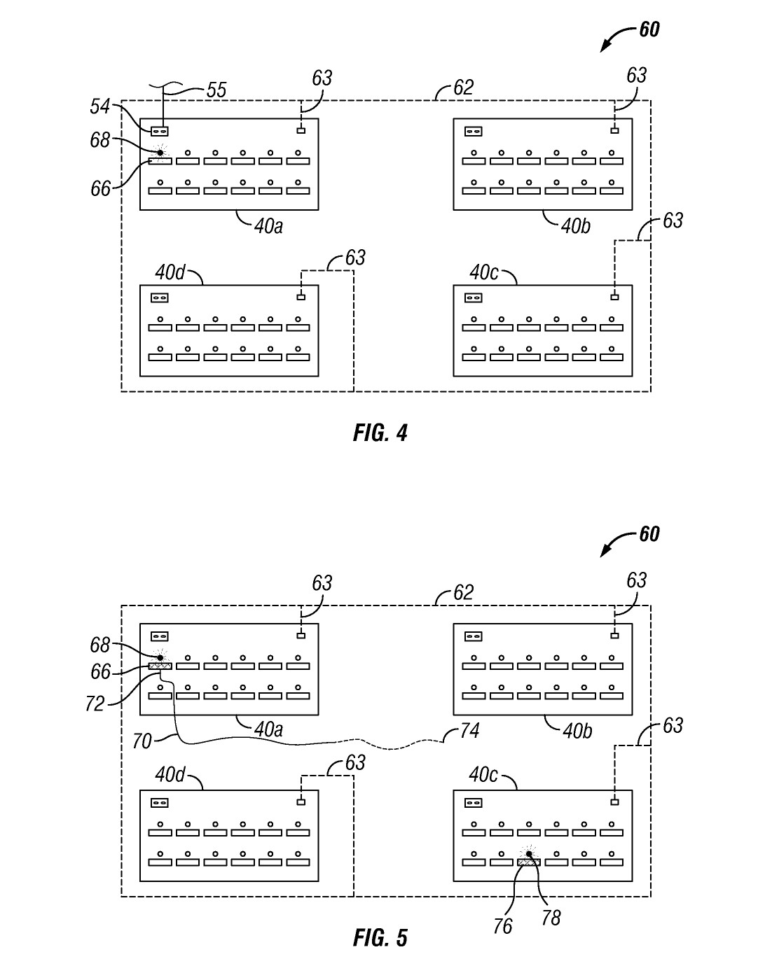

FIGS. 4-7 are schematic diagrams illustrating some of the sequential steps for connecting a group of servers 40a, 40b, 40c, 40d in a computer system 60. To simplify explanation, each of the servers 40a-40d are assumed to be substantially identical to the server 40 of FIG. 3. Like reference numerals refer to substantially similar features.

FIG. 4 is a schematic diagram showing the group of servers 40a-40d connected on a back channel 62 for guided connection according to the invention. A power cable 55 connected to the power port 54 supplies power to the server 40a. Other power cables used to power the other servers 40b-40d are omitted from the figure. The back channel 62 may be formed by connecting the servers 40a-40d using Ethernet cables 63 plugged into Ethernet ports 56. The order of connecting the Ethernet ports 56 is generally not important. The back channel 62 provides at least limited data communication between the servers 40a-40d. A predetermined cabling sequence may be encoded in a set of instructions embodied in a computer readable medium accessible by the primary service processor. Communicating on the back channel 62, the primary service processor first selectively illuminates the visual indicator 68 on the server 40a, indicating to a user that an associated connection port 66 is the first to be connected according to the predetermined cabling sequence.

FIG. 5 is a schematic diagram of the servers 40a-40d, wherein one end 72 of a cable 70 has been connected to the connection port 66 on the server 40a in response to illumination of the associated visual indicator 68. A primary service processor disposed on the server 40a or another of the servers 40a-40d detects when the end 72 of the cable 70 is connected to the connection port 66 and causes illumination of the visual indicator 78 in response. This indicates to a user that the associated connection port 76 is the next connection port to be connected in the sequence. Accordingly, a second end 74 of the cable 70 may be subsequently connected to the connection port 76.

Together, a connection port on one server to be connected to a connection port on another server constitute a “connector pair.” For example, the connection ports 66 and 76 constitute a connector pair to be connected by the cable 70. In some embodiments, the cabling sequence may be specific to the sequence of connecting each of the individual connectors. In other embodiments, the cabling sequence may be generalized to a sequence of connector pairs connected without regard to the order in which the two connectors of each connector pair are connected. Thus, for example, with regard to the connector pair 66, 76, it may not matter whether the cable 70 is connected first to the connection port 66 (FIG. 4) or the connection port 76 (FIG. 5), so long as the connector pair 66, 76 are connected according to a desired sequence of connector pairs. Both of the visual indicators 68, 78 may be illuminated simultaneously, guiding a user to connect the cable 70 between the two ports 66, 76, without regard to which connection port 66, 76 is connected first.

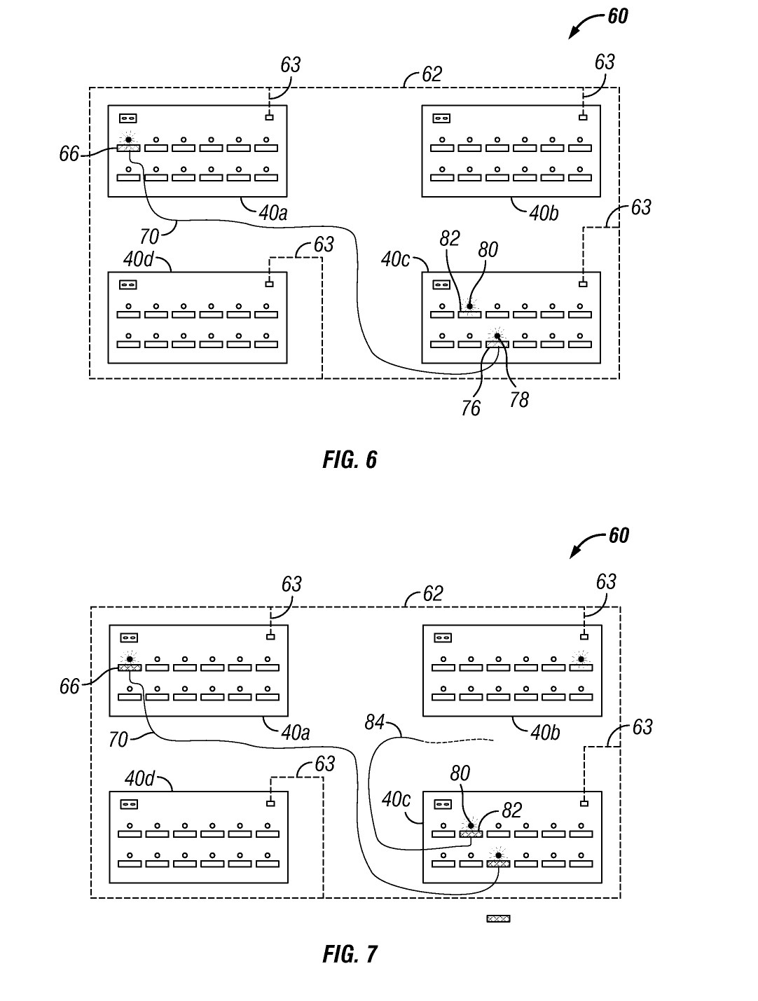

FIG. 6 is a schematic diagram of the servers 40a-40d wherein another end of the cable 70 has been connected to another connection port 76 in response to illumination of the visual indicator 78, thereby completing the connection between connection port 66 and connection port 76. The computer system 60 may signal a completed connection between the connector pair 66, 76 by selectively operating one or both of the visual indicators 68, 78. Another visual indicator 80 is now illuminated, which directs a user to now connect to the associated connection port 82.

FIG. 7 is a schematic diagram of the servers 40a-40d after one end of another cable 84 has been connected to the connection port 82 in response to illumination of the visual indicator 80. The visual indicator 86 is now illuminated, signaling a user to make a connection to the next connection port 88 to be connected according to the predetermined cabling sequence. Another end of the cable 84 may be subsequently connected by a user to the connection port 88 in response to the illumination of the visual indicator 86. As illustrated, the connection ports 82 and 88 are connected sequentially, though in other embodiments it may not matter whether the cable 84 is connected first to the connection port 82 or the connection port 88.

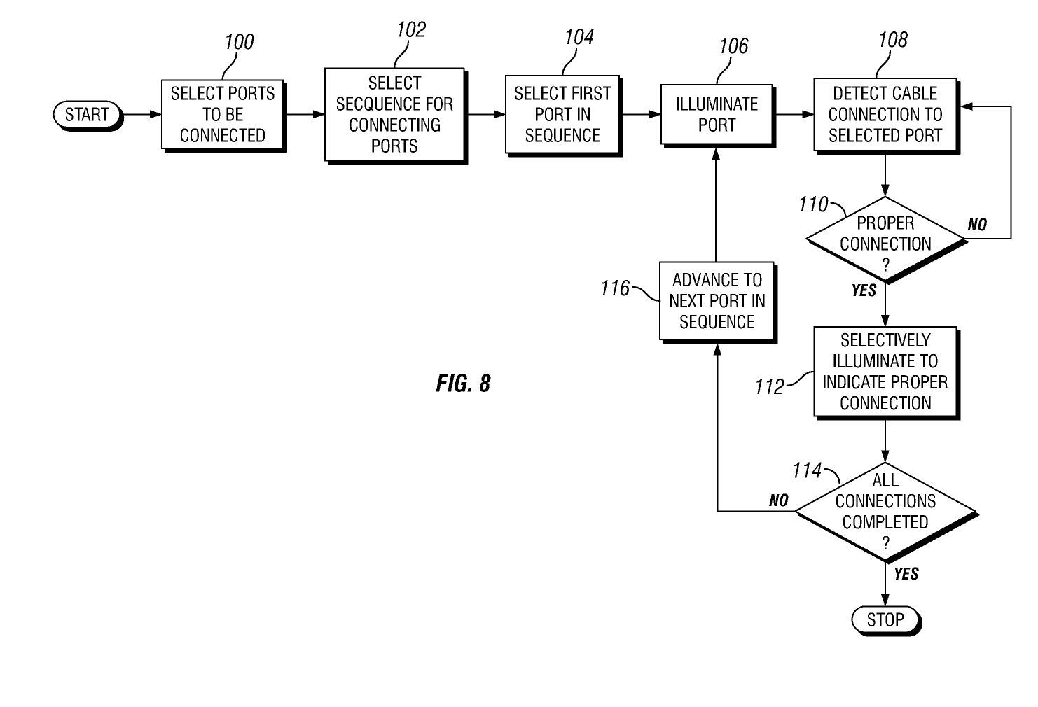

FIG. 8 is a flowchart describing a method for guiding electronic connections between nodes of a computer system. The method may be implemented with computer usable program code contained on a computer usable medium and accessible by the computer system. The computer system includes a plurality of nodes. Each node may be, for example, a server having a plurality of connection ports. The connections between the servers may be performed using cables used to connect the connection ports. In step 100, the connection ports to be connected are determined. In step 102, the sequence of connecting the connection ports is determined. The connection ports to be connected and the sequence of connecting the connection ports may be pre-determined by a system designer and written into the program code. A primary service processor residing on one of the servers may thereby determine the connection ports and their sequence of connection by accessing the program code. Alternatively, the steps 100, 102 may comprise selecting a sequence based on the desired configuration of the computer system. The computer program code may alternatively include program code for computing a desired configuration and connection sequence based on a number of parameters, such as the number of servers, the model of servers, and the desired system configuration.

After the ports and their connection sequence are selected, the connection ports may be sequentially illuminated and connected. In step 104, the first port in the sequence may be selected by the primary service processor or other logic component of the computer system. The visual indicator associated with the connection port selected in step 104 may be illuminated in step 106. In step 108, connection of a cable to the selected port is monitored for detection. In step 110, if no connection to the selected port is detected, the status of the associated visual indicator may remain unchanged. Also, if the end of a cable is improperly connected to the selected connection port, the status of the visual indicator may remain unchanged. Alternatively, improper connection of the cable to the selected connection port may optionally cause a change in the visual status of the associated visual indicator in such a way to indicate the improper connection to the user. For example, an improper connection may be indicated in step 110 by changing the illumination of the associated visual indicator from one color to another, such as from blue to red. In step 112, once a proper connection to the selected connection port is detected, the associated visual indicator may be selectively illuminated to indicate the proper connection. For example, proper connection to the selected connection port may cause the associated visual indicator to change colors, such as from blue to green. In step 114, if more connection ports remain to be connected, the computer system may advance to the next connection port in sequence according to step 116. Step 106 may then be repeated, illuminating the next connection port selected in step 116. Otherwise, if all the connections are successfully completed in step 114, the computer system is properly connected.

Other visual indicator operations may be performed to visually indicate connection-related information to the user, such as to sequentially indicate the connection ports or connector pairs to be connected in the sequence (step 106), to signal a proper or improper connection with a selected port (step 110), or to signal a completed connection between two ports of a connector pair. Non-limiting examples of the visual indicator operations include switching a visual indicator from OFF to ON, from ON to OFF, from one color to another, adjusting the brightness, to change from one blinking pattern to another blinking pattern, or displaying confirmation messages using an LCD.

It should be recognized that the invention may take the form of an embodiment containing hardware and/or software elements. Non-limiting examples of software include firmware, resident software, and microcode. More generally, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device. For example, computer-usable or computer-readable code may be stored on a primary service processor included with a server to be connected. Alternatively, computer-usable or computer-readable code may be stored on another device with which the primary service processor can communicate, such as a semiconductor or solid state memory, a random access memory (RAM), a read-only memory (ROM), a rigid magnetic disk, or an optical disk. Examples of optical disks include compact disk-read only memory (CD-ROM), compact disk-read/write (CD-R/W), and DVD.

Input/output (I/O) devices such as keyboards, displays, or pointing devices can be coupled to a computer system, either directly or through intervening I/O controllers. Network adapters may also be used to allow the data processing system to couple to other data processing systems or remote printers or storage devices, such as through intervening private or public networks. Modems, cable modems, Ethernet cards, and wireless network adapters are examples of network adapters.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer program product comprising a computer usable medium containing computer usable program code for guiding electronic connections between nodes of a computer system, the computer program product including program code usable by a service processor included with one or more of the nodes, for selectively operating visual indicators associated with connection ports included with the nodes according to a sequence of connections to be made between the nodes.

2. The computer program product of claim 1, further comprising:
computer usable program code for detecting connections made to the connection ports; and
computer usable program code for selectively operating the visual indicators in response to the detected connections.

3. The computer program product of claim 1, further comprising:
computer usable program code for detecting a connection of a cable to one of the connection ports; and
computer usable program code for operating a visual indicator associated with the one of the connection ports in response to the detected connection of the cable to the one of the connection ports.

4. The computer program product of claim 3, wherein the visual indicator operated in response to the detected connection of the cable is disposed on the cable.

5. The computer program product of claim 1, further comprising:
computer usable program code for detecting a completed connection between a first connection port included with a first node and a second connection port included with a second node, and operating one or more of the visual indicators in response.

6. The computer program product of claim 1, wherein the computer usable program code for selectively operating visual indicators comprises computer usable program code for selectively changing an illumination color of the visual indicators.

7. The computer program product of claim 1, wherein the visual indicators are selected from LEDs, lamps, LCDs, and combinations thereof.

8. The computer program product of claim 1, further comprising computer usable program code for determining the sequence of connections to be made.

9. The computer program product of claim 1, further comprising computer usable program code for determining a cabling configuration for connecting the nodes.

10. The computer program product of claim 1, wherein the nodes to be connected include one or more servers.

11. The computer program product of claim 1, wherein the sequence of connections includes a sequence of connector pairs.

12. The computer program product of claim 11, wherein the connector pairs include a connection port included with one of the nodes and a connection port included with another of the nodes.

13. A system comprising:
a plurality of nodes, each node including one or more connection ports and a service processor in electronic communication with the one or more connection ports;
a plurality of selectively-operable visual indicators, each associated with one of the connection ports; and
wherein a selected one of the service processors controls operation of the visual indicators according to a sequence of electronic connections to be made between the connection ports.

14. The system of claim 13, wherein the plurality of nodes include one or more servers.

15. The system of claim 13, wherein the visual indicators are selectively changeable between at least two different visual outputs.

16. The system of claim 15, wherein the visual indicators are selectively changeable between an illuminated condition and a substantially non-illuminated condition.

17. The system of claim 15, wherein the two or more visual indicators are selectively changeable between a first color and a second color.

18. The system of claim 13, wherein the visual indicators are selected from LEDs, lamps, LCDs, and combinations thereof.

19. The system of claim 13, further comprising a plurality of electronic cables for connecting the connection ports.

20. The system of claim 19, wherein one or more of the visual indicators are disposed on the electronic cables.
